(19) United States
(12) Patent Application Publication
(10) Pub. No.: US 2024/0355526 A1
(43) Pub. Date: Oct. 24, 2024

(54) REACTOR, CONVERTER, AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinichiro YAMAMOTO, Mie (JP); Kazuhiro INABA, Mie (JP); Masaya MURASHITA, Mie (JP)

(21) Appl. No.: 18/684,340

(22) PCT Filed: Aug. 8, 2022
(86) PCT No.: PCT/JP2022/030252

§ 371 Date: Feb. 16, 2024

(30) Foreign Application Priority Data
Aug. 27, 2021 (JP) 2021-138708

(51) Int. Cl. H01F 27/255; H01F 1/20; H02M 5/18

(52) U.S. Cl. CPC H01F 27/255; H01F 1/20; H02M 5/18

(57) ABSTRACT

A magnetic core includes an E-shaped first core portion, a T-shaped second core portion, and a gap portion, the first core portion is formed of a molded body made of a composite material, the second core portion is formed of a powder compact, the gap portion is disposed between a first middle core portion of the first core portion and a second middle core portion of the second core portion, a length from a second end surface of the winding portion to the gap portion is 0.2 times or more and 0.49 times or less a length of the winding portion, and a total volume of a volume of the first core portion, a volume of the second core portion, and a volume of the gap portion is 50 cm³ or more and 500 cm³ or less.

### TECHNICAL FIELD

The present disclosure relates to a reactor, a converter, and a power conversion device.

This application is based upon and claims the benefit of priority from Japanese Patent Application No. 2021-138708 filed in Japan on Aug. 27, 2021, the entire content of which is hereby incorporated by reference.

### BACKGROUND

The reactor disclosed in Patent Document 1 includes a coil, a magnetic core, a case, and a cooling pipe. The coil is formed by spirally winding a wire. The number of coils is one, and the shape of the coil is cylindrical. The magnetic core includes an inner core portion and an outer core portion. The inner core portion is disposed inside the coil. The outer core portion covers both end surfaces of the inner core portion and both end surfaces and an outer circumferential surface of the coil. The inner core portion and the outer core portion are made of different materials. Specifically, the inner core portion is formed of a powder compact, and the outer core portion is formed of a molded body made of a composite material. The case houses the assembly of the coil and the magnetic core. The assembly can be housed in the case by arranging the coil and the inner core portion in the case, filling the case with a raw material of the composite material, and curing the raw material. A refrigerant flows through the cooling pipe. The cooling pipe is spirally wound in the circumferential direction of the case so as to be in contact with the outer circumferential surface of the case.

### PRIOR ART DOCUMENT

### Patent Document

Patent Document 1: JP 2013-074062 A

### SUMMARY OF THE INVENTION

A reactor of the present disclosure is a reactor including a coil and a magnetic core,

wherein the coil includes a winding portion,

the number of winding portions is one,

an outer circumferential surface of the winding portion includes a portion that contacts an installation target for the reactor,

the magnetic core includes:
an E-shaped first core portion and a T-shaped second core portion combined in an axial direction of the winding portion; and
a gap portion provided between the first core portion and the second core portion,

the first core portion is formed of a molded body made of a composite material in which a first end core portion facing a first end surface of the winding portion, a first middle core portion having a portion disposed inside the winding portion, and a first side core portion and a second side core portion disposed on an outer circumference of the winding portion so as to sandwich the first middle core portion are integrated,

the second core portion is formed of a powder compact in which a second end core portion facing a second end surface of the winding portion and a second middle core portion having a portion disposed inside the winding portion are integrated,

a length of the second middle core portion in the axial direction of the winding portion is shorter than a length of the first middle core portion in the axial direction of the winding portion,

the gap portion is disposed between the first middle core portion and the second middle core portion inside the winding portion,

a length from the second end surface to the gap portion is 0.2 times or more and 0.49 times or less a length of the winding portion, and

a total volume Va of a volume of the first core portion, a volume of the second core portion, and a volume of the gap portion is 50 cm³ or more and 500 cm³ or less.

A converter of the present disclosure includes the reactor of the present disclosure.

A power conversion device of the present disclosure includes the converter of the present disclosure.

### BRIEF DESCRIPTION OF THE DRAWINGS

FIG. 1 is a schematic perspective diagram showing a reactor according to a first embodiment.

FIG. 2 is a schematic side view showing the entire reactor of the first embodiment.

FIG. 3 is a schematic perspective view showing a state where the reactor of the first embodiment is disassembled.

FIG. 4 is a schematic top view showing the entire reactor of the first embodiment.

FIG. 5 is a configuration diagram schematically showing a power supply system of a hybrid vehicle.

FIG. 6 is a circuit diagram showing an example of a power conversion device that includes a converter.

### DETAILED DESCRIPTION TO EXECUTE THE INVENTION

### Technical Problem

In the above-described assembly, the inner core portion and the outer core portion are made of different materials, and thus the inductance is easily adjusted. On the other hand, in the assembly, the coil and the inner core portion are embedded in the outer core portion, and therefore, it is difficult to adjust the heat dissipation. This is because the surface of the assembly is substantially constituted only by the constituent material of the outer core portion. In addition, the assembly has low heat dissipation. This is because the outer core portion is made of a composite material and has a relatively low thermal conductivity. In view of this, the above-described reactor is configured such that the heat dissipation performance of the assembly is enhanced by housing the assembly in the case around which the cooling pipe is wound. However, the reactor increases in size because the cooling pipe is wound around the case.

An object of the present disclosure is to provide a reactor that facilitates adjustment of inductance and heat dissipation without increasing in size. Another object of the present disclosure is to provide a converter including the reactor. Still another object of the present disclosure is to provide a power conversion device including the converter.

### Advantageous Effects of Present Disclosure

The reactor of the present disclosure facilitates adjustment of inductance and heat dissipation without increasing in size.

The converter and the power conversion device of the present disclosure have excellent heat dissipation without increasing in size.

### DESCRIPTION OF EMBODIMENTS OF THE PRESENT DISCLOSURE

First, embodiments of the present disclosure will be listed and described.
(1) A reactor according to an embodiment of the present disclosure is a reactor including a coil and a magnetic core,
wherein the coil includes a winding portion,
the number of winding portions is one,
an outer circumferential surface of the winding portion includes a portion that contacts an installation target for the reactor,
the magnetic core includes:
   an E-shaped first core portion and a T-shaped second core portion combined in an axial direction of the winding portion; and
   a gap portion provided between the first core portion and the second core portion,
the first core portion is formed of a molded body made of a composite material in which a first end core portion facing a first end surface of the winding portion, a first middle core portion having a portion disposed inside the winding portion, and a first side core portion and a second side core portion disposed on an outer circumference of the winding portion so as to sandwich the first middle core portion are integrated,
the second core portion is formed of a powder compact in which a second end core portion facing a second end surface of the winding portion and a second middle core portion having a portion disposed inside the winding portion are integrated,
a length of the second middle core portion in the axial direction of the winding portion is shorter than a length of the first middle core portion in the axial direction of the winding portion,
the gap portion is disposed between the first middle core portion and the second middle core portion inside the winding portion,
a length from the second end surface to the gap portion is 0.2 times or more and 0.49 times or less a length of the winding portion, and
a total volume Va of a volume of the first core portion, a volume of the second core portion, and a volume of the gap portion is 50 cm³ or more and 500 cm³ or less.

The inductance of the reactor is easily adjusted. In particular, in the reactor, the inductance is easily adjusted without a large gap portion between the first core portion and the second core portion. This is because the magnetic core is not made of a single material, but is made of the first core portion formed of a molded body made of a composite material and the second core portion formed of a powder compact.

In the reactor, it is easy to adjust the heat dissipation as compared with the above-described conventional reactor. A magnetic core of a conventional reactor is formed by embedding a core portion having a relatively high thermal conductivity in a core portion having a relatively low thermal conductivity. That is to say, the surface of the magnetic core of the conventional reactor is equivalent to being made of a single material. In contrast, in the reactor, the magnetic core is formed by combining the first core portion and the second core portion in the axial direction of the winding portion, and thus the surface of the magnetic core is formed of different materials.

In the reactor, the heat dissipation is easily enhanced. This is because the winding portion of the reactor includes a portion that is in contact with the installation target, and therefore the heat of the coil can be effectively released through the installation target. In particular, in the reactor, the heat dissipation is easily enhanced as compared with the above-described conventional reactor. In the above-described conventional reactor, the surface of the magnetic core is formed only by the core portion having a relatively low thermal conductivity as described above. In contrast, the reactor can include a surface of the magnetic core formed of a powder compact having a relatively high thermal conductivity.

The reactor can be suitably used as a reactor cooled by a cooling member having a bias in cooling performance. Of the first core portion and the second core portion, the second core portion having higher thermal conductivity is disposed on the side of the cooling member having lower cooling performance, and the first core portion having lower thermal conductivity is disposed on the side of the cooling member having higher cooling performance. With this configuration, the first core portion and the second core portion are uniformly cooled, and the maximum temperature of the magnetic core is reduced.

The reactor is less likely to increase in size. This is because the reactor facilitates adjustment of the heat dissipation as described above, that is to say, facilitates enhancing the heat dissipation, and thus does not need to be provided with a cooling pipe as in the conventional reactor described above.

In the reactor, the number of winding portions is one, and the installation area in the direction orthogonal to the axial direction can be reduced as compared with a reactor in which a plurality of winding portions are disposed in parallel in the direction orthogonal to the axial direction of the winding portion.

The reactor is easy to manufacture. This is because the reactor is formed by simply assembling the first core portion and the second core portion, which are produced in advance, to the coil.

The reactor has low loss. This is because, in the reactor, the length of the second middle core portion is shorter than the length of the first middle core portion, and thus the ratio of the powder compact having a larger loss than the molded body made of the composite material is small. In addition, in the reactor, the gap portion is disposed inside the winding portion, and the length from the second end surface to the gap portion is 0.2 times or more the length of the winding portion, and thus the leakage of the magnetic flux is less likely to enter the winding portion. Therefore, the eddy current loss generated in the winding portion is easily reduced. Furthermore, the length from the second end surface to the gap portion is 0.49 times or less the length of the winding portion, and therefore, the ratio of the molded body made of the composite material having a lower loss than the powder compact can be increased in the winding portion. In addition, the reactor can reduce the maximum temperature of the magnetic core as described above.

By employing the reactor, it is possible to suppress problems such as the influence on peripheral devices of leakage of the magnetic flux. This is because, in the reactor, the gap portion is disposed inside the winding portion, and the length from the second end surface to the gap portion is 0.2 times or more the length of the winding portion, and therefore, the leakage of the magnetic flux to the outside of the winding portion is easily suppressed.

The second core portion having a T-shape is easy to manufacture compared to the case where the second core portion has an E-shape. Accordingly, the second core portion having a T-shape is easy to manufacture with high accuracy, compared to the case where the second core portion has an E-shape. As a result, the second core portion having a T-shape is less likely to have unnecessary gaps when combined with the first core portion, as compared to the case where the second core portion has an E-shape.

The reactor is suitable for a converter of an electric vehicle, a hybrid vehicle, or a fuel cell vehicle because the total volume Va is 50 cm³ or more and 500 cm³ or less.

In general, the larger the volume of the reactor, the more easily heat is generated and the less easily heat is dissipated. However, in the reactor, the heat dissipation is easily enhanced as described above, and therefore, even when the total volume Va is 50 cm³ or more, the heat generation is easily suppressed.
(2) In the reactor according to (1), a ratio of the volume of the second core portion to the total volume Va may be 25% or more and 40% or less.

When the ratio is 25% or more, the heat dissipation of the reactor is likely to be high. When the ratio is 40% or less, the loss of the reactor is likely to be reduced.
(3) In the reactor according to (1) or (2), a ratio of a volume of the second middle core portion to a total volume of a volume of the first middle core portion, the volume of the second middle core portion, and a volume of the gap portion may be 15% or more and 49% or less.

When the ratio is 15% or more, the heat dissipation of the reactor is likely to be high. When the ratio is 49% or less, the loss of the reactor is likely to be reduced.
(4) In the reactor according to any one of (1) to (3), a ratio of a thickness of the gap portion to a total length of a length of the first middle core portion, a length of the second middle core portion, and the thickness of the gap portion may be 0.001 or more and 0.1 or less.

When the ratio is 0.001 or more, a predetermined inductance is easily secured. When the ratio is 0.1 or less, the leakage of the magnetic flux is small, and the effect of reducing the eddy current loss is likely to be high.
(5) In the reactor according to any one of (1) to (4), the thickness of the gap portion may be 0.1 mm or more and 2 mm or less.

When the thickness is 0.1 mm or more, a predetermined inductance is easily secured. When the thickness is 2 mm or less, the leakage of the magnetic flux is small, and the effect of reducing eddy current loss is likely to be high.
(6) In the reactor according to any one of (1) to (5), a molded resin portion that covers at least a portion of the magnetic core and forms the gap portion may be provided.

In the reactor, the gap portion is formed of the molded resin portion, and thus the gap between the end surface of the first middle core portion and the end surface of the second middle core portion is easily maintained. In addition, in the reactor, the magnetic core covered with the molded resin portion is easily protected from the external environment.

In the reactor, the gap portion is easily formed by a part of the molded resin portion. The reason is as follows. The gap portion constituted by a part of the molded resin portion is formed as follows. An assembly of the coil and the magnetic core is prepared. The constituent material of the molded resin portion is spread from the outside of the assembly toward the space between the end surface of the first middle core portion and the end surface of the second middle core portion inside the winding portion. Even when the total volume Va is 50 cm³ or more, the length from the second end surface to the gap portion is 0.49 times or less the length of the winding portion, and the constituent material of the molded resin portion is easily spread between the end surfaces.
(7) In the reactor according to any one of (1) to (6), the reactor may constitute a converter of an electric vehicle, a hybrid vehicle, or a fuel cell vehicle.

The reactor is suitable for constituting the converter.
(8) In the reactor according to any one of (1) to (7), the powder compact may be a compact of raw material powder containing soft magnetic powder, and a content of the soft magnetic powder in the powder compact may be 85% by volume or more and 99% by volume or less.

The magnetic properties of the powder compact are easily improved as compared with a molded body made of a composite material.
(9) In the reactor according to any one of (1) to (8), the molded body made of the composite material may be a molded body in which soft magnetic powder is dispersed in a resin, and a content of the soft magnetic powder in the compact of the composite material may be 20% by volume or more and 80% by volume or less.

The magnetic properties of the molded body made of the composite material are easily adjusted and the molded body is easily formed into a complicated shape as compared with a powder compact.
(10) A converter according to an aspect of the present disclosure includes the reactor according to any one of (1) to (9).

The converter includes the reactor, and thus has excellent heat dissipation and low loss without increasing in size.

(11) A power conversion device according to an aspect of the present disclosure includes the converter according to (10).

The power conversion device includes the converter, and thus has excellent heat dissipation and low loss without increasing in size.

### DETAILS OF EMBODIMENTS OF PRESENT DISCLOSURE

Details of embodiments of the present disclosure will be described below with reference to the drawings. Like reference numerals in the drawings indicate elements having like names.

### First Embodiment

### [Reactor]

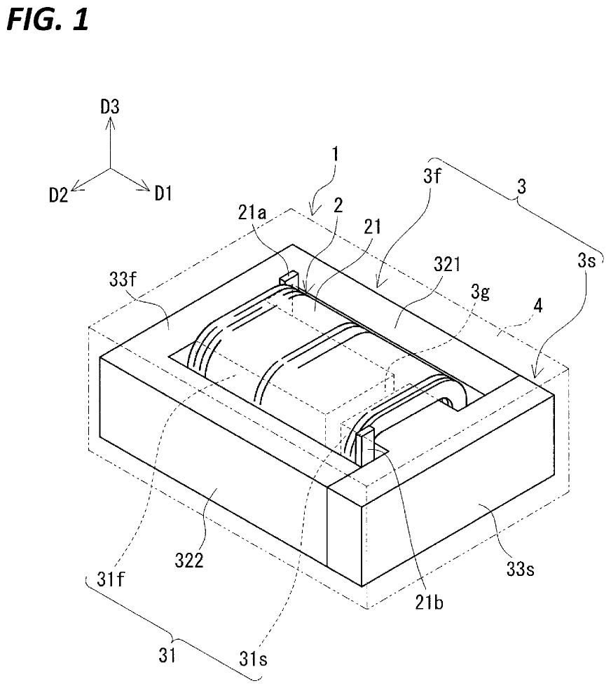

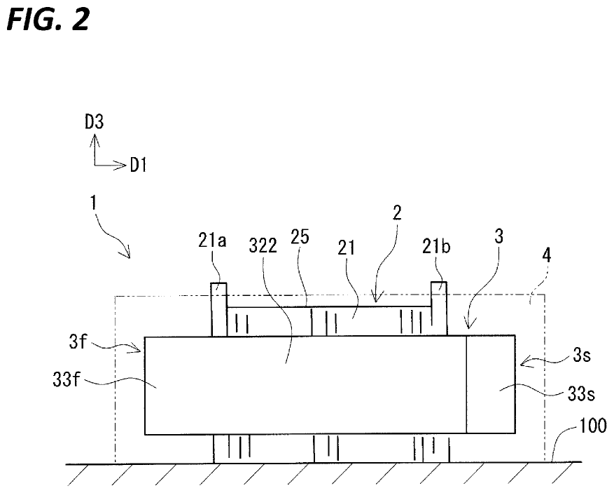

A reactor 1 of a first embodiment will be described with reference to FIGS. 1 to 4. The reactor 1 includes a coil 2 and a magnetic core 3. The coil 2 has a winding portion 21. The number of winding portions 21 is one. One of the features of the reactor 1 of the present embodiment is that the following requirements (a) to (f) are satisfied.
(a) As shown in FIG. 2, the outer circumferential surface 25 of the winding portion 21 includes a portion that is in contact with the installation target 100 for the reactor 1.
(b) As shown in FIG. 1, the magnetic core 3 includes an E-shaped first core portion 3f and a T-shaped second core portion 3s combined in the axial direction of the winding portion 21, and a gap portion 3g provided between the first core portion 3f and the second core portion 3s.
(c) The first core portion 3f is formed of a molded body made of a composite material, and the second core portion 3s is formed of a powder compact.
(d) A first middle core portion 31f included in the first core portion 3f and a second middle core portion 31s included in the second core portion 3s each have a specific length.
(e) The gap portion 3g is located at a specific position.
(f) The volume of the magnetic core 3 has a specific size.

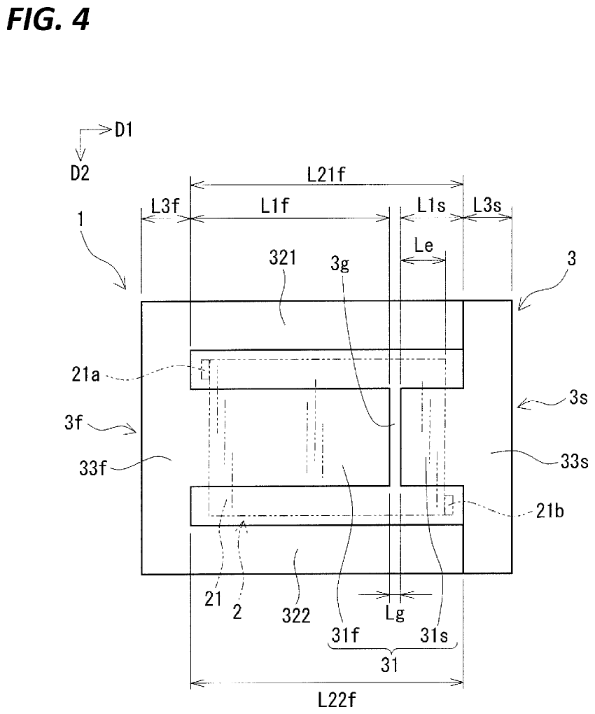

In FIG. 4, the coil 2 is shown with a dashed double-dotted line for convenience in the description. In the following description, a first direction D1, a second direction D2, and a third direction D3 defined as follows may be used.

The first direction D1 is a direction extending along the axial direction of the winding portion 21.

The second direction D2 is a direction extending along a direction in which the first middle core portion 31f, a first side core portion 321, and a second side core portion 322, which will be described later, are disposed in parallel.

The third direction D3 is a direction orthogonal to both the first direction D1 and the second direction D2.

### [Coil]

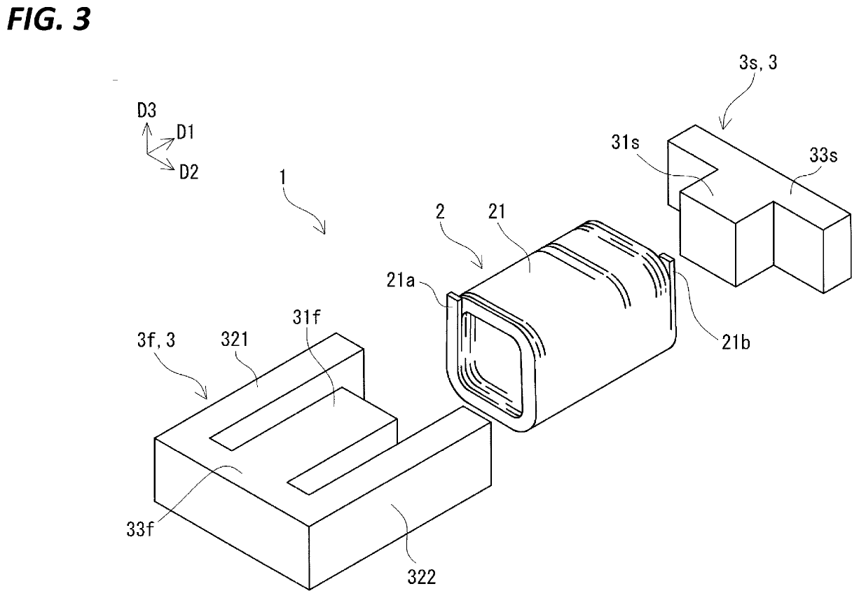

As shown in FIG. 3, the coil 2 has a hollow winding portion 21. The winding portion 21 is formed by spirally winding a single wire having no joint portions. The number of winding portions 21 is one. The reactor 1 of the present embodiment has one winding portion 21, and thus the length of the reactor 1 can be shorter in the second direction D2 than a reactor in which a plurality of winding portions are disposed in parallel in a direction orthogonal to the axial direction of the winding portions.

The winding portion 21 has a rectangular tubular shape. “Rectangular” includes rectangular and square shapes. The end surface shape of the winding portion 21 of the present embodiment is a rectangular frame shape. The shape of the winding portion 21 is a rectangular tube shape, and thus it is easy to increase the contact area between the winding portion 21 and the installation target 100, compared to a case where the winding portion 21 is a circular tube shape having the same cross-sectional area. For this reason, the reactor 1 can easily dissipate heat to the installation target 100 via the winding portion 21. Moreover, the winding portion 21 can be easily installed stably on the installation target 100. An example of the installation target 100 is a cooling base or an inner bottom surface of a case described later. The corners of the winding portion 21 are rounded. Unlike the present embodiment, the shape of the winding portion 21 may be a circular tube shape. The circular shape includes a perfect circle and an ellipse.

A known wire can be used for the wire. A covered flat wire is used as the wire of the present embodiment. The conductor wire of the covered flat wire is constituted by a copper flat wire. The insulating coating of the covered flat wire is made of enamel. The winding portion 21 is constituted by an edgewise coil obtained by winding the covered flat wire edgewise.

In the present embodiment, the first end portion 21a and the second end portion 21b of the winding portion 21 are extended to the outside of the winding portion 21 at the first end portion and the second end portion of the winding portion 21 in the axial direction, respectively. Although not shown, the insulating coating of the first end portion 21a and the second end portion 21b is peeled off, and the conductive wire is exposed. As shown in FIG. 2, the exposed conductor wires are drawn out of the molded resin portion 4 described later in the present embodiment. Terminal members are connected to the exposed conductor wires. The terminal members are not shown. An external device is connected to the coil 2 via the terminal members. The external device is not shown. The external device is a power source that supplies electrical power to the coil 2, for example.

The outer circumferential surface 25 of the winding portion 21 has a portion that is in contact with the installation target 100 for the reactor 1. Accordingly, in the reactor 1, the heat dissipation can be easily improved. The outer circumferential surface 25 has a portion protruding further in the third direction D3 than the magnetic core 3. That is to say, the length of the winding portion 21 in the third direction D3 is longer than the length of the magnetic core 3 in the third direction D3. In the present embodiment, the shape of the winding portion 21 is a rectangular tube shape, and the outer circumferential surface 25 of the winding portion 21 has four flat surfaces. In the present embodiment, one of the four flat surfaces is a portion that comes into contact with the installation target 100. As a result, the winding portion 21 can secure a sufficient contact area with respect to the installation target 100. Accordingly, the heat dissipation of the reactor 1 is further easily enhanced. In the present embodiment, the contact area of the winding portion 21 is exposed from the molded resin portion 4 described later. Therefore, the heat of the coil 2 is easily released through the installation target 100.

### [Magnetic Core]

As shown in FIG. 1, the magnetic core 3 is an assembly of the first core portion 3f and the second core portion 3s in the first direction D1. The gap portion 3g described later is provided between the first core portion 3f and the second core portion 3s. The magnetic core 3 can be constructed by combining the first core portion 3f and the second core portion 3s in the first direction D1, and thus the reactor 1 has excellent manufacturing workability. The combination of the first core portion 3f and the second core portion 3s is an E-T type. This combination makes it easier to adjust the inductance and the heat dissipation. The first core portion 3f is formed of a molded body made of a composite material described later. The second core portion 3s is constituted by a powder compact described later.

A total volume Va of the volume of the first core portion 3f, the volume of the second core portion 3s, and the volume of the gap portion 3g is 50 cm³ or more and 500 cm³ or less. The reactor 1 having the total volume V of 50 cm³ or more and 500 cm³ or less is suitable for a converter of an electric vehicle, a hybrid vehicle, or a fuel cell vehicle. The winding portion 21 has a portion that is in contact with the installation target 100, and the second core portion 3s is formed of a powder compact, and therefore, even when the total volume Va is 50 cm³ or more, the heat of the magnetic core 3 is easily released.

The total volume Va is 500 cm³ or less, and thus the reactor 1 is less likely to be excessively large. The total volume Va is further 60 cm³ or more and 400 cm³ or less, and particularly preferably 70 cm³ or more and 300 cm³ or less. The volume of the gap portion 3g is a volume of space surrounded by the end surface of the first middle core portion 31f, the end surface of the second middle core portions 31s, and the virtual outer circumferential surface. The virtual outer circumferential surface is an outer circumferential surface obtained by extending the outer circumferential surface of the first middle core portion 31f in the first direction D1.

### (First Core Portion)

The planar shape of the first core portion 3f is an E-shape as shown in FIG. 4. The planar shape of the first core portion 3f refers to a shape of the first core portion 3f viewed from the third direction D3. The definition of the planar shape is the same for a second core portion 3s described later. The first core portion 3f includes a first end core portion 33f, a first middle core portion 31f, a first side core portion 321, and a second side core portion 322. The first end core portion 33f faces a first end face of the winding portion 21. The term “face” means that the first end core portion 33f and the first end surface of the winding portion 21 face each other. The first middle core portion 31f includes a portion disposed inside the winding portion 21. The first side core portion 321 and the second side core portion 322 are disposed to face each other with the first middle core portion 31f sandwiched therebetween. The first side core portion 321 and the second side core portion 322 are disposed on the outer circumference of the winding portion 21.

As shown in FIG. 3, the first core portion 3f is a molded body in which the first end core portion 33f, the first middle core portion 31f, the first side core portion 321, and the second side core portion 322 are integrated. The first end core portion 33f connects the first middle core portion 31f, the first side core portion 321, and the second side core portion 322. The first side core portion 321 and the second side core portion 322 are provided at both ends of the first end core portion 33f. The first middle core portion 31f is provided at the center of the first end core portion 33f. The first core portion 3f is formed of a molded body made of a composite material described later.

The shape of the first end core portion 33f is a thin prismatic shape in the present embodiment. The shape of the first middle core portion 31f is a shape corresponding to the inner circumferential shape of the winding portion 21. The shape of the first middle core portion 31f of the present embodiment is a quadrangular prismatic shape. The corner portions of the first middle core portion 31f are shown as angular in FIG. 3, but are rounded so as to follow the inner circumferential surfaces of the corner portions of the winding portion 21. The first side core portion 321 and the second side core portion 322 have the same shape. In the present embodiment, the first side core portion 321 and the second side core portion 322 each have a thin prismatic shape.

The total of the cross-sectional area of the first side core portion 321 and the cross-sectional area of the second side core portion 322 is the same as the cross-sectional area of each of the first middle core portion 31f and the second middle core portion 31s. The cross-sectional area mentioned here is the cross-sectional area of a cut section orthogonal to the first direction D1.

As shown in FIG. 4, the length L1f of the first middle core portion 31f in the first direction D1 is shorter than the length of the winding portion 21 in the first direction D1. The length of the winding portion 21 in the first direction D1 is the length of the winding portion 21 between the first end surface and the second end surface in the first direction D1. When there are gaps between the turns of the winding portion 21, the length of the winding portion 21 in the first direction D1 include the lengths of the gaps between the turns. The length of the first middle core portion 31f in the second direction D2 is longer than each of the length of the first side core portion 321 in the second direction D2 and the length of the second side core portion 322 in the second direction D2. As shown in FIG. 1, the length of the first middle core portion 31f in the third direction D3 is equal to each of the length of the first side core portion 321 in the third direction D3 and the length of the second side core portion 322 in the third direction D3.

As shown in FIG. 4, the length L21f of the first side core portion 321 in the first direction D1 is equal to the length L22f of the second side core portion 322 in the first direction D1. The length L21f and the length L22f are longer than the length L1f, and are also longer than the length of the winding portion 21 in the first direction D1. The length of the first side core portion 321 in the second direction D2 is equal to the length of the second side core portion 322 in the second direction D2. As shown in FIG. 1, the length of the first side core portion 321 in the third direction D3 is equal to the length of the second side core portion 322 in the third direction D3.

### (Second Core Portion)

The planar shape of the second core portion 3s is a T-shape as shown in FIG. 4. The second core portion 3s includes a second end core portion 33s and a second middle core portion 31s. The second end core portion 33s faces a second end face of the winding portion 21. The term “face” means that the second end core portion 33s and the second end surface of the winding portion 21 face each other. The second middle core portion 31s includes a portion disposed inside the winding portion 21.

As shown in FIG. 3, the second core portion 3s is a molded body in which the second end core portion 33s and the second middle core portion 31s are integrated. The second middle core portion 31s is provided at the center of the second end core portion 33s. The second core portion 3s is constituted by a powder compact described later. The powder compact having a T-shape is easy to manufacture compared to the powder compact having an E-shape. Accordingly, the powder compact having a T-shape is easy to manufacture with high accuracy as compared with the powder compact having an E-shape. Accordingly, the second core portion 3s having a T-shape is less likely to have unnecessary gaps when combined with the first core portion 3f, as compared with the second core portion 3s having an E-shape.

The shape of the second end core portion 33s is the same shape as the shape of the first end core portion 33f. That is to say, the second end core portion 33s has a thin prismatic shape. The second middle core portion 31s has a quadrangular prismatic shape. The corners of the second middle core portion 31s are rounded along the inner circumferential surface of the corners of the winding portion 21.

As shown in FIG. 4, the length L1s of the second middle core portion 31s in the first direction D1 is shorter than the length L1f. The total length of the length L1s and the length L1f is shorter than each of the length L21f and the length L22f. The length of the second middle core portion 31s in the second direction D2 is equal to the length of the first middle core portion 31f in the second direction D2. As shown in FIG. 1, the length of the second middle core portion 31s in the third direction D3 is equal to the length of the first middle core portion 31f in the third direction D3.

As shown in FIG. 4, the length L3s of the second end core portions 33s in the first direction D1 is equal to the length L3f of the first end core portion 33f in the first direction D1. The length of the second end core portions 33s in the second direction D2 is equal to the length of the first end core portion 33f in the second direction D2. The length of the second end core portion 33s in the second direction D2 is longer than the length of the winding portion 21 in the second direction D2. As shown in FIG. 1, the length of the second end core portion 33s in the third direction D3 is equal to the length of the first end core portion 33f in the third direction D3. As shown in FIG. 2, the length of the second end core portion 33s in the third direction D3 is shorter than the length of the winding portion 21 in the third direction D3. As shown in FIG. 1, the length of the second end core portion 33s in the third direction D3 is equal to the length of the second middle core portion 31s in the third direction D3.

An example of the volume ratio Vps obtained by (volume Vs/total volume Va)×100 is 25% or more and 40% or less. The volume Vs is the volume of the second core portion 3s. As described above, the total volume Va is the total volume of the volume of the first core portion 3f, the volume of the second core portion 3s, and the volume of the gap portion 3g. When the volume ratio Vps is 25% or more, the heat dissipation of the reactor 1 is likely to be high. When the volume ratio Vps is 40% or less, the loss of the reactor 1 is likely to be reduced. The volume ratio Vps is further 27% or more and 38% or less, and particularly preferably 29% or more and 36% or less.

An example of the volume ratio Vpm obtained by (volume Vms/total volume Vma)×100 is 15% or more and 49% or less. The volume Vms is the volume of the second middle core portion 31s. The total volume Vma is the total volume of the volume of the first middle core portion 31f, the volume of the second middle core portion 31s, and the volume of the gap portion 3g. When the ratio Vpm is 15% or more, the heat dissipation of the reactor 1 is likely to be high. When the ratio Vpm is 49% or less, the loss of the reactor 1 is likely to be reduced. The ratio Vpm is further 20% or more and 40% or less, and particularly preferably 25% or more and 35% or less.

The first core portion 3f and the second core portion 3s are combined such that the end surface of the first side core portion 321 and the end surface of the second side core portion 322 are in contact with the end surface of the second end core portion 33s. A space is provided between the end surface of the first middle core portion 31f and the end surface of the second middle core portion 31s. The gap portion 3g described later is provided between the end surface of the first middle core portion 31f and the end surface of the second middle core portion 31s.

The molded body made of the composite material constituting the first core portion 3f is a molded body in which soft magnetic powder is dispersed in a resin. The molded body made of the composite material is obtained by filling a mold with a fluid material in which soft magnetic powder is dispersed in an unsolidified resin and solidifying the resin. In the molded body made of the composite material, the content of the soft magnetic powder in the resin can be easily adjusted. Accordingly, in the molded body made of the composite material, the magnetic properties are easily adjusted. Furthermore, the molded body made of the composite material is easily formed into a complicated shape as compared with the powder compact. An example of the content of the soft magnetic powder in the molded body made of the composite material is 20% by volume or more and 80% by volume or less. The content of the resin in the molded body made of the composite material is, for example, 20% by volume or more and 80% by volume or less. These contents are values in a case where the molded body made of the composite material is 100% by volume.

The powder compact constituting the second core portion 3s is a compact obtained by compression-molding soft magnetic powder. Compared with a molded body made of the composite material, the powder compact can have a higher ratio of the soft magnetic powder in the core portion. For this reason, it is easy to enhance the magnetic properties of the powder compact. The magnetic properties include relative permeability and saturation magnetic flux density. Also, a powder compact includes a smaller amount of resin and a larger amount of soft magnetic powder than a molded body made of the composite material, and therefore has excellent heat dissipation. The content of the magnetic powder in the powder compact is, for example, 85% by volume or more and 99% by volume or less. This content is a value in a case where the powder compact is 100% by volume.

The particles constituting the soft magnetic powder are particles of a soft magnetic metal, coated particles, particles of a soft magnetic nonmetal, or the like. The coated particles include particles of a soft magnetic metal and insulating coating provided on the outer circumference of the particles of the soft magnetic metal. Examples of soft magnetic metals include pure iron and an iron-based alloy. Examples of iron-based alloys include Fe—Si alloy and Fe—Ni alloy. An example of an insulating coating is phosphate. An example of a soft magnetic nonmetal is ferrite.

An example of the resin of the molded body made of the composite material is a thermosetting resin or a thermoplastic resin. Examples of thermosetting resins include epoxy resins, phenol resins, silicone resins, and urethane resins. Examples of thermoplastic resins include polyphenylene sulfide resins, polyamide resins, liquid crystal polymers, polyimide resins, and fluorine resins. Examples of polyamide resins include nylon 6, nylon 66, and nylon 9T.

The molded body made of the composite material may contain a ceramic filler. An example of the ceramic filler is alumina or silica. The ceramic filler contributes to improvement in heat dissipation and electrical insulation.

The content of the soft magnetic powder in the molded body made of the composite material and the content of the soft magnetic powder in the powder compact are regarded as being equivalent to the area ratio of the soft magnetic powder in each of the cross sections of the molded body made of the composite material and the powder compact. The content of the soft magnetic powder in the molded body made of the composite material and the powder compact is determined as follows. A cross section of each of the molded body made of the composite material and the powder compact is observed with a scanning electron microscope (SEM) to obtain an observation image. The cross section of each of the molded body made of the composite material and the powder compact is any cross section. The magnification of the SEM is 200 times or more and 500 times or less. The number of observation images is 10 or more. The total cross-sectional area is set to be 0.1 cm² or more. One observation image may be obtained for one cross section, or a plurality of observation images may also be obtained for one cross section. The obtained observation images are subjected to image processing to extract the outlines of the particles. The image processing is, for example, binarization processing. The area ratio of the soft magnetic particles in each observation image is calculated, and the average value of the area ratios is obtained. The average value is regarded as the content of the soft magnetic powder.

As described above, the first core portion 3f is formed of a molded body made of a composite material, and the second core portion 3s is formed of a powder compact. The first core portion 3f is constituted by a molded body of a composite material, and the second core portion 3s is constituted by a powder compact, and therefore, the inductance is easily adjusted without providing the long gap portion 3g, and the heat dissipation is easily adjusted. Furthermore, the second core portion 3s of the reactor 1 is formed of a powder compact having a relatively high heat transfer rate, and thus the heat dissipation is easily enhanced.

### (Gap Portion)

The gap portion 3g is disposed inside the winding portion 21. The gap portion 3g is provided between the end surface of the first middle core portion 31f and the end surface of the second middle core portion 31s. The gap portion 3g is provided inside the winding portion 21, and therefore, the leakage of the magnetic flux is less likely to enter the winding portion 21 than in the case where the gap portion 3g is provided outside the winding portion 21. For this reason, the eddy current loss generated in the winding portion 21 is easily reduced. The gap portion 3g is formed of a member made of a material having a lower relative permeability than the first core portion 3f and the second core portion 3s. The gap portion 3g of the present embodiment is constituted by a part of the molded resin portion 4 described later.

An example of the ratio of the thickness of the gap portion 3g to the total length of the length L1f, the length L1s, and the thickness of the gap portion 3g is 0.001 or more and 0.1 or less. The thickness of the gap portion 3g is the length Lg of the gap portion 3g in the first direction D1. When the ratio is 0.001 or more, a predetermined inductance is easily secured. When the ratio is 0.1 or less, the leakage of the magnetic flux is small, and the effect of reducing the eddy current loss is likely to be high. The ratio is more preferably 0.01 or more and 0.08 or less, and particularly preferably 0.02 or more and 0.06 or less.

An example of the thickness of the gap portion 3g is 0.1 mm or more and 2 mm or less. When the thickness is 0.1 mm or more, a predetermined inductance can be easily secured. When the thickness is 2 mm or less, the leakage of the magnetic flux is small, and the effect of reducing the eddy current loss is likely to be high. The thickness is more preferably 0.3 mm or more and 1.75 mm or less, and particularly preferably 0.5 mm or more and 1.5 mm or less.

An example of the length Le from the second end surface of the winding portion 21 to the gap portion 3g in the first direction D1 is 0.2 times or more and 0.49 times or less the length of the winding portion 21 in the first direction D1. The length Le is a length in the first direction D1 of a portion between the second end surface and a portion of the gap portion 3g closest to the second end surface.

The length Le is 0.2 times or more the length of the winding portion 21 in the first direction D1, and thus the leakage of the magnetic flux is less likely to enter the winding portion 21. For this reason, the eddy current loss generated in the winding portion 21 is easily reduced. The closer the length Le is to 0.5 times the length of the winding portion 21 in the first direction D1, that is to say, the closer the position of the gap portion 3g is to the center of the winding portion 21 in the first direction D1, the more the effect of reducing eddy current loss is likely to be enhanced.

The length Le is 0.49 times or less the length of the winding portion 21 in the first direction D1, and thus the ratio of the molded body made of the composite material having a lower loss than the powder compact can be increased, and the loss of the reactor 1 is low. In addition, the length Le is 0.49 times or less the length of the winding portion 21 in the first direction D1, and thus the gap portion 3g formed by a portion of the molded resin portion 4 is easily produced. The gap portion 3g constituted by a part of the molded resin portion 4 is formed as follows. An assembly of the coil 2 and the magnetic core 3 is prepared. The constituent material of the molded resin portion 4 is spread from the outside of the assembly toward the space between the end surface of the first middle core portion 31f and the end surface of the second middle core portion 31s inside the winding portion 21. The length Le is 0.49 times or less the length of the winding portion 21 in the first direction D1, and therefore, even when the total volume Va is 50 cm³ or more, the constituent material of the molded resin portion 4 can easily spread between the end surfaces. As the length Le is shorter, the constituent material of the molded resin portion 4 can be easily spread between the end surfaces.

The length Le is further 0.2 times or more and 0.4 times or less the length 0.25 times or more and 0.375 times or less the length of the winding portion 21 in the first direction D1.

[Molded resin portion]

As shown in FIG. 1, the molded resin portion 4 covers at least a part of the magnetic core 3 and forms the gap portion 3g. The molded resin portion 4 may cover the outer circumference of the magnetic core 3 and not cover the outer circumference of the coil 2, or may cover both the outer circumferences of the magnetic core 3 and the outer circumference of the coil 2. For convenience of explanation, the molded resin portion 4 described later is omitted in FIG. 4.

As shown in FIG. 2, the molded resin portion 4 of the present embodiment covers the outer circumference of the assembly of a part of the coil 2 and the magnetic core 3. Accordingly, the assembly is substantially protected from the external environment. In the present embodiment, a flat surface of the outer circumferential surface 25 of the coil 2 on the installation target side is exposed from the molded resin portion 4. The outer circumferential surface 25 of the coil 2 is covered with the molded resin portion 4 except for the flat surface on the installation target side. The entire outer circumference of the magnetic core 3 is covered with the molded resin portion 4. The molded resin portion 4 is provided between the winding portion 21 and the first middle core portion 31f, between the winding portion 21 and the second middle core portion 31s, and between the end surface of the first middle core portion 31f and the end surface of the second middle core portion 31s. The coil 2 and the magnetic core 3 are integrated by the molded resin portion 4. An example of the resin of the molded resin portion 4 is the same resin as the resin of the molded body of the composite material described above. The resin of the molded resin portion 4 may contain a ceramic filler, as in the case of the molded body made of the composite material.

### [Other Matters]

Although not shown, the reactor 1 may include at least one of a case, an adhesive layer, and a holding member. The case houses the assembly of the coil 2 and the magnetic core 3 therein. The assembly housed in the case may be embedded in a sealing resin portion. The case is installed on a cooling base or the like. The adhesive layer fixes the assembly to the cooling base or the inner bottom surface of the case, or fixes the case to the cooling base. The holding member is provided between the coil 2 and the magnetic core 3, and ensures insulation between the coil 2 and the magnetic core 3.

In the reactor 1, the inductance is easily adjusted without increasing the thickness of the gap portion 3g. This is because the magnetic core 3 is not formed of a single material, but is formed of the first core portion 3f formed of a molded body made of a composite material and the second core portion 3s formed of a powder compact.

In the reactor 1, the heat dissipation is easily enhanced. This is because the winding portion 21 includes a portion that is in contact with the installation target 100, and thus it is possible to effectively dissipate heat of the coil 2 through the installation target 100. This is also because the surface of the magnetic core 3 includes a surface formed of a powder compact having a relatively high thermal conductivity.

The reactor 1 can be suitably used as a reactor cooled by a cooling member having a bias in cooling performance. The second core portion 3s having a high thermal conductivity is disposed on the side of the cooling member having a low cooling capacity, and the first core portion 3f having a low thermal conductivity is disposed on the side of the cooling member having a high cooling capacity. With this configuration, the first core portion 3f and the second core portion 3s are uniformly cooled, and the maximum temperature of the magnetic core 3 is reduced.

The reactor 1 is less likely to increase in size. This is because the reactor 1 is easy to adjust and increase the heat dissipation as described above, and thus does not need to be provided with a cooling pipe as in the conventional reactor described above.

The reactor 1 has low loss. This is because the length L1s is shorter than the length L1f, and the ratio of the powder compact having a larger loss than the molded body made of the composite material is small. The gap portion 3g is disposed inside the winding portion 21, the length Le is 0.2 times or more the length of the winding portion 21, and thus the leakage of the magnetic flux is less likely to enter the winding portion 21. Accordingly, the eddy current loss generated in the winding portion 21 is easily reduced. Furthermore, the length Le is 0.49 times or less the length of the winding portion 21, and thus the ratio of the molded body made of the composite material having a lower loss than the powder compact can be increased inside the winding portion 21. In addition, as described above, the maximum temperature of the magnetic core 3 is reduced.

The use of the reactor 1 can suppress the problem that the leakage of the magnetic flux affects peripheral devices. This is because the gap portion 3g is disposed inside the winding portion 21, the length Le is 0.2 times or more the length of the winding portion 21, and therefore, it is easy to suppress the leakage of the magnetic flux to the outside of the winding portion 21.

In the reactor 1, the gap portion 3g is easily formed using a part of the molded resin portion 4. The length Le is 0.49 times or less the length of the winding portion 21. That is to say, the space serving as the gap portion 3g is close to the second end surface of the winding portion 21. Accordingly, even when the total volume Va is 50 cm³ or more, the constituent material of the molded resin portion 4 is easily spread between the end surface of the first middle core portion 31f and the end surface of the second middle core portion 31s inside the winding portion 21.

### Second Embodiment

### [Converter and Power Conversion Device]

The reactor 1 of the first embodiment can be used for applications satisfying the following energization conditions. The energization conditions are, for example, that the maximum direct current is about 100 A or more and 1000 A or less, the mean voltage is about 100V or more and 1000V or less, and the operating frequencies are about 5 kHz or more and 100 kHz or less. The reactor 1 of the first embodiment can be typically used as a component of a converter mounted in a vehicle 1200 such as an electric vehicle, a hybrid vehicle, or a fuel cell vehicle, or a component of a power conversion device including the converter.

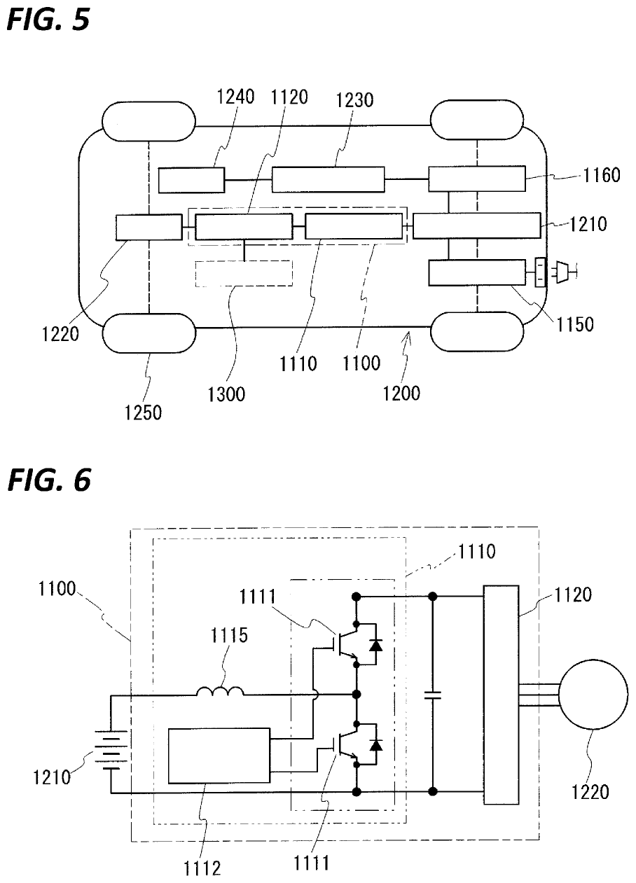

As shown in FIG. 5, the vehicle 1200 includes a main battery 1210, a power conversion device 1100 to be connected to the main battery 1210, and a motor 1220 that is driven by electric power supplied from the main battery 1210 and used for traveling of the vehicle 1200. The motor 1220 is typically a three-phase AC motor, drives wheels 1250 during traveling of the vehicle 1200 and functions as a generator during regeneration. In the hybrid vehicle, the vehicle 1200 includes an engine 1300 in addition to the motor 1220. Although an inlet is shown as a charging point of the vehicle 1200 in FIG. 5, the vehicle 1200 may include a plug.

The power conversion device 1100 includes a converter 1110 to be connected to the main battery 1210, and an inverter 1120 to be connected to the converter 1110 and configured to perform mutual conversion between direct current (DC) and alternating current (AC). The converter 1110 shown in this example steps up the input voltage of the main battery 1210, which is about 200 V or more and 300 V or less, to about 400 V or more and 700 V or less and supplies the power to the inverters 1120 while the vehicle 1200 is traveling. The converter 1110 steps down an input voltage output from the motor 1220 via the inverter 1120 to a DC voltage suitable for the main battery 1210 and charges the main battery 1210, during regeneration. The input voltage is a DC voltage. The inverter 1120 converts the direct current stepped-up by the converter 1110 into a predetermined alternating current to supply the motor 1220 with the alternating current while the vehicle 1200 is traveling, and converts an alternating current output from the motor 1220 into a direct current and outputs the direct current to the converter 1110 during regeneration.

As shown in FIG. 6, the converter 1110 includes a plurality of switching elements 1111, a drive circuit 1112 that controls the operation of the switching elements 1111, and a reactor 1115, and converts an input voltage by repeating ON and OFF. In this case, the conversion of the input voltage means step-up and step-down of the input voltage. A power device such as a field effect transistor or an insulated gate bipolar transistor is used as the switching element 1111. The reactor 1115 smooths the change of a current when the current is going to increase or decrease by the switching operation, by utilizing the property of the coil that tries to prevent the change of the current that is going to flow through the circuit. The reactor 1 of the first embodiment is provided as the reactor 1115. By providing the reactor 1 having excellent heat dissipation and low loss without increasing in size, it is possible to also expect miniaturization, improvement in heat dissipation, and reduction in loss in the power conversion device 1100 and the converter 1110.

The vehicle 1200 includes, in addition to the converter 1110, a power supplying device converter 1150 connected to the main battery 1210, and an auxiliary power supply converter 1160 that is connected to the sub-battery 1230 serving as a power source of the auxiliary machines 1240, and the main battery 1210 and converts a high voltage of the main battery 1210 into a low voltage. The converter 1110 typically performs DC-DC conversion, whereas the power supplying device converter 1150 and the auxiliary power supply converter 1160 perform AC-DC conversion. The power supplying device converter 1150 may perform DC-DC conversion. A reactor having the same configuration as the reactor 1 of the first embodiment and the like and appropriately changed in size, shape, and the like can be used as the reactor of the power supplying device converter 1150 and the auxiliary power supply converter 1160. The reactor 1 of the first embodiment and the like can also be used in a converter that converts input power and performs only stepping-up of a voltage or stepping down of a voltage.

The present invention is not limited to these examples, but is defined by the scope of the claims, and is intended to include all modifications within the meaning and scope equivalent to the scope of the claims.

### LIST OF REFERENCE NUMERALS

1: Reactor
2: Coil
21: Winding portion, 21a: First end portion, 21b: Second end portion
25: Outer circumference surface
3: Magnetic core, 3f: First core portion, 3s: Second core portion,
31f: First middle core portion, 31s: Second middle core portion
321: First side core portion, 322: Second side core portion
33f: First end core portion, 33s: Second end core portion
3g: Gap portion
4: Molded resin portion
L1f, L1s, L21f, L22f, L3f, L3s, Le: Length
D1: First direction, D2: Second direction, D3: Third direction
100: Installation target
1100: Power conversion device, 1110: Converter
1111: Switching element, 1112: Drive circuit, 1115: Reactor
1120: Inverter
1150: Power supplying device converter, 1160: Auxiliary power supply converter
1200: Vehicle
1210: Main battery, 1220: Motor, 1230: Sub-battery
1240: Auxiliary machine, 1250: Wheel
1300: Engine

1. A reactor comprising a coil and a magnetic core,
wherein the coil includes a winding portion,
the number of winding portions is one,
an outer circumferential surface of the winding portion includes a portion that contacts an installation target for the reactor,
the magnetic core includes:
an E-shaped first core portion and a T-shaped second core portion combined in an axial direction of the winding portion; and
a gap portion provided between the first core portion and the second core portion,
the first core portion is formed of a molded body made of a composite material in which a first end core portion facing a first end surface of the winding portion, a first middle core portion having a portion disposed inside the winding portion, and a first side core portion and a second side core portion disposed on an outer circumference of the winding portion so as to sandwich the first middle core portion are integrated,
the second core portion is formed of a powder compact in which a second end core portion facing a second end surface of the winding portion and a second middle core portion having a portion disposed inside the winding portion are integrated,
a length of the second middle core portion in the axial direction of the winding portion is shorter than a length of the first middle core portion in the axial direction of the winding portion,
the gap portion is disposed between the first middle core portion and the second middle core portion inside the winding portion,
a length from the second end surface to the gap portion is 0.2 times or more and 0.49 times or less a length of the winding portion, and
a total volume Va of a volume of the first core portion, a volume of the second core portion, and a volume of the gap portion is 50 cm³ or more and 500 cm³ or less.

2. The reactor according to claim 1,
wherein a ratio of the volume of the second core portion to the total volume Va is 25% or more and 40% or less.

3. The reactor according to claim 1,
wherein a ratio of a volume of the second middle core portion to a total volume of a volume of the first middle core portion, the volume of the second middle core portion, and a volume of the gap portion is 15% or more and 49% or less.

4. The reactor according to claim 1,
wherein a ratio of a thickness of the gap portion to a total length of a length of the first middle core portion, a length of the second middle core portion, and the thickness of the gap portion is 0.001 or more and 0.1 or less.

5. The reactor according to claim 1,
wherein the thickness of the gap portion is 0.1 mm or more and 2 mm or less.

6. The reactor according to claim 1,
wherein a molded resin portion that covers at least a portion of the magnetic core and forms the gap portion is provided.

7. The reactor according to claim 1,
wherein the reactor constitutes a converter of an electric vehicle, a hybrid vehicle, or a fuel cell vehicle.

8. The reactor according to claim 1, wherein
the powder compact is a compact of raw material powder containing soft magnetic powder, and
a content of the soft magnetic powder in the powder compact is 85% by volume or more and 99% by volume or less.

9. The reactor according to claim 1, wherein
the molded body made of the composite material is a molded body in which soft magnetic powder is dispersed in a resin, and
a content of the soft magnetic powder in the molded body made of the composite material is 20% by volume or more and 80% by volume or less.

10. A converter comprising the reactor according to claim 1.

11. A power conversion device comprising the converter according to claim 10.
